(19) United States
(12) Patent Application Publication
(10) Pub. No.: US 2005/0099163 A1
(43) Pub. Date: May 12, 2005

(54) Temperature manager

(75) Inventor: Carl F. Liepold, Chandler, AZ (US)

Correspondence Address: DONALD J. LENKSZUS, PO BOX 3064, CAREFREE, AZ, 85377-3064, US

(73) Assignee: ANDIGILOG, INC., Chandler, AZ (US)

(21) Appl. No.: 10/897,217

(22) Filed: Jul. 22, 2004

Related U.S. Application Data
(63) Continuation-in-part of application No. 10/704,368, filed on Nov. 8, 2003.

(51) Int. Cl. G01K 17/06

(52) U.S. Cl. 320/150

(57) ABSTRACT

A temperature manager, in accordance with the principles of the invention provides for comparing the temperatures at a plurality of zones of an apparatus with at least one predetermined temperature level. An output indication of the temperatures is provided on a single line output.

### FIELD OF THE INVENTION

This invention pertains to temperature sensing apparatus.

### BACKGROUND OF THE INVENTION

Temperature sensing is frequently used to control the operation of apparatus. Typically a single temperature sensor is utilized. It is desirable to provide an improved arrangement for sensing temperatures of an apparatus.

### SUMMARY OF THE INVENTION

In accordance with the principles of the invention, a system is provided that automatically samples the temperature measured by a plurality of temperature sensors and automatically compares the temperature at each sensor to predetermined temperature level trip points and has a interface to pass the status of all the devices to a controller.

In accordance with the invention, apparatus is provided that includes a plurality of temperature sensors. Each temperature sensor is operable to generate a signal representative of the temperature of the temperature sensor. The apparatus includes a comparator circuit operable to compare temperature sensor temperature signals to at least one predetermined level representative of a predetermined temperature. The selector circuit is coupled to each temperature sensor and to the comparator circuit. The selector circuit is adapted to selectively activate the temperature sensors, and further adapted to couple outputs from each selectively activated temperature sensor to the comparator circuit. A control circuit is coupled to the selector circuit. The control circuit is adapted to energize the selector circuit at predetermined intervals and is adapted to cause the selector to selectively activate each temperature sensor one at a time during the predetermined intervals and to cause the selector to couple each selected temperature sensor to the comparator circuit.

In accordance with one aspect of the invention the comparator circuit, the selector circuit and the control circuit are formed in a silicon substrate.

In accordance with another aspect of the invention a current source is coupled to the selector circuit and is adapted to energize each temperature sensor selected by said selector circuit for a predetermined time.

In accordance with another aspect of the invention, the comparator circuit, the selector circuit, the control circuit, and the current source are all formed on a single substrate.

In accordance with the illustrative embodiment of the invention, the comparator circuit is operable to compare a temperature sensor temperature signal to a plurality of predetermined levels, each representative of a corresponding one of a plurality of predetermined temperatures.

Still further in accordance with the invention, an interface circuit is coupled to the comparator to interface the comparator circuit to a single wire output. In the illustrative embodiment of the invention the interface circuit generates pulse width modulated signals at the single wire output.

In accordance with another feature of the invention, the comparator circuit is operable to determine if a temperature sensor is inoperable.

In the illustrative embodiment of the invention, each of the temperature sensors is disposed in a different thermal zone. In one embodiment of the invention, the temperature sensors are disposed on a substrate which is a flexible substrate. The substrate is disposed in proximity to a plurality of batteries. Each battery of the plurality of batteries comprises a lithium ion type battery.

In another embodiment of the invention, the temperature sensor substrate comprises a circuit board. The said circuit board comprises a mother board which in turn comprises a microprocessor.

Still further in accordance with the principles of the invention each temperature sensor of the plurality of sensors comprises a silicon substrate, each silicon substrate having formed thereon a bandgap, an offset circuit for providing calibration offsets; and a gain block.

The offset block comprises a plurality of resistors formed in a sensor silicon substrate, and a programmable link structure configurable to provide a predetermined offset such that the temperature sensor is permanently calibrated.

A method for monitoring temperature for apparatus having a plurality of thermal zones, in accordance with the invention, comprises the steps of: providing a plurality of temperature sensors, each temperature sensor being operable to generate a signal representative of the temperature of said temperature sensor; disposing each temperature sensor in a corresponding one thermal zone of a plurality of thermal zones; providing temperature monitoring apparatus; operating the temperature monitoring apparatus at periodic intervals and turning the temperature monitoring apparatus off intermediate the periodic intervals; energizing the temperature sensors during the periodic intervals and de-energizing the temperature sensors intermediate the periodic intervals; selectively coupling each temperature sensor during the periodic intervals to a comparator; comparing temperature sensor temperature signals to at least one predetermined level representative of a predetermined temperature.

In accordance with an aspect of the invention, the method may include the step of selectively activating each temperature sensor of the plurality of temperature sensors one at a time during the predetermined intervals; and coupling each activated temperature sensor to the comparator during each of the predetermined intervals.

Still further in accordance with another aspect of the invention, the method comprises the steps of providing a single current source for energizing each of the temperature sensors; and coupling the single current source to each of the temperature sensors one at a time during the periodic intervals.

In accordance with another aspect of the invention the method comprises comparing the temperature sensor temperature signals to a plurality of predetermined levels each representative of a corresponding predetermined temperature of a plurality of temperatures.

In accordance with an aspect of the invention, the method comprises providing an output indicative of the temperatures of the temperature sensors relative to the corresponding plurality of temperatures.

In accordance with yet a further aspect of the invention, the method comprises providing the output via a single output line. In the illustrative embodiment of the invention the output is provided as a pulse width modulated signal.

### BRIEF DESCRIPTION OF THE DRAWING

The invention will be better understood from a reading of the following detailed description of preferred embodiments of the invention in conjunction with the drawing figures in which the sizes of and distances between various elements is not representative of actual physical sizes or distances between various elements and in which like designators are used to identify like or similar elements, and in which:

FIG. 1 illustrates apparatus in accordance with the invention in conjunction with a battery pack;

FIG. 2 is a block diagram of apparatus in accordance with the invention;

FIG. 3 illustrates the steps in a method in accordance with the principles of the invention;

FIG. 4 illustrates a circuit board in accordance with the principles of the invention;

FIG. 5 illustrates a two terminal temperature sensing circuit in accordance with the principles of the invention;

FIG. 6 illustrates a three terminal temperature sensing circuit in accordance with the principles of the invention;

FIG. 7 is a diagram of a bandgap circuit of a type advantageously utilized in the sensors of FIGS. 5 and 6;

FIG. 8 is a block diagram of the device of FIG. 5;

FIG. 9 is a block diagram of the device of FIG. 6;

FIG. 10 is a diagram of a temperature sensor that is particularly well adapted for use in apparatus in accordance with the principles of the invention;

### DETAILED DESCRIPTION

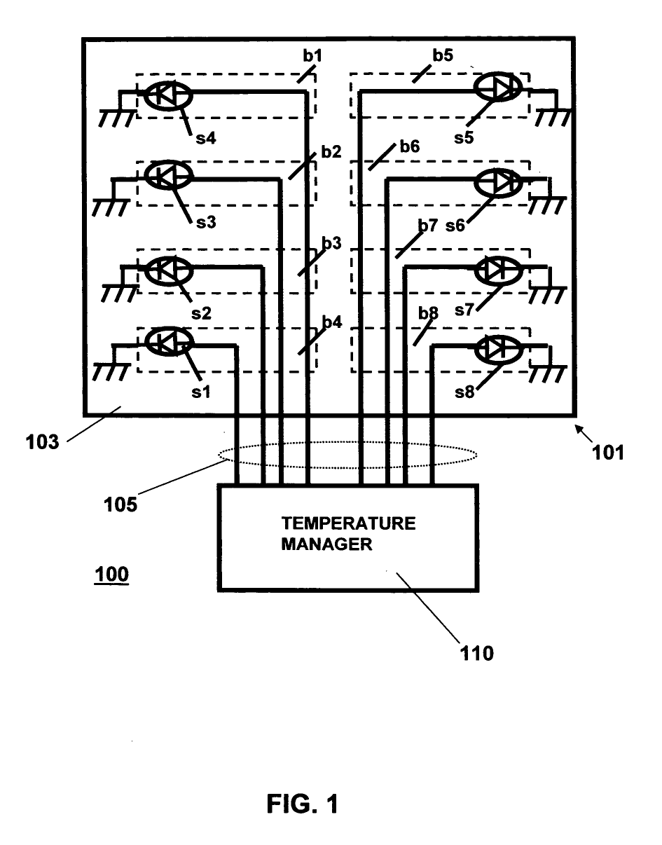

FIG. 1 shows apparatus 100 in accordance with the principles of the invention. Apparatus 100 is a lithium ion battery pack 101 that includes a plurality of battery cells b1-b8. Disposed proximate battery cells b1-b8 are a plurality of temperature sensors s1-s8. Each temperature sensor s1-s8 is disposed on a substrate 103 that, in the illustrative embodiment shown, is a flexible circuit board. It will be understood by those skilled in the art that the configuration of apparatus 100 is intended to be illustrative of the invention and is not in anyway intended to limit the invention or to be an accurate representation of apparatus to which the present invention is advantageously applied. For example, the various ones of battery cells b1-b8 may be disposed in multiple planes rather than in the single plane as shown. In such an instance, temperature sensors s1-s8 would be disposed in planes such that temperature sensors would be proximate corresponding battery cells b1-b8.

Temperature sensors s1-s8 each has at least one common connection, shown as a ground, and a dedicated connection 105 for each sensor s1-s8. In the illustrative embodiment of the invention, the connections 105 to sensors s1-s8 are brought off substrate 103 to a temperature manager 110.

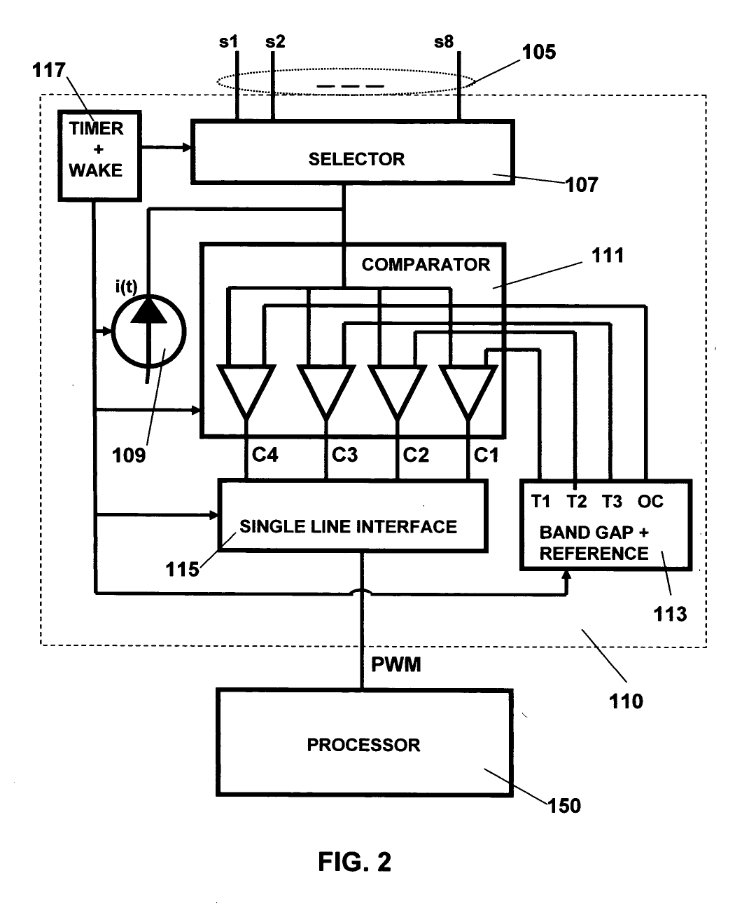

Turning now to FIG. 2, temperature manager 110 is shown in block diagram form. Connections 105 from sensors s1-s8 are coupled to a selector 107. Selector 107 selectively couples each of sensors s1-s8, one at a time, to current source 109, and to comparator 111. Each sensor s1-s8 when energized or activated by current source 109 provides an output signal on its corresponding connection 105. The output signals are representative of the temperature of the corresponding temperature sensor, which in turn is the temperature of the thermal zone in which temperature sensor is disposed. In the illustrative embodiment of FIG. 1, each thermal zone corresponds to one battery cell b1-b8. Comparator 111 compares the temperature sensor temperature signal to reference level corresponding to at least one predetermined temperature level T1. In the embodiment shown, each temperature sensor temperature signal is also compared to a second reference level corresponding to a second predetermined temperature level T2 and to a third reference level signal corresponding to a third predetermined temperature level T3. In addition, each temperature sensor temperature signal is compared to a fourth reference level that is selected to correspond to an open or failure condition of a temperature sensor. Although the illustrative embodiment compares each temperature sensor temperature signal to three predetermined temperature levels T1, T2, T3, it will be appreciated by those skilled in the art that the comparison may be made against one predetermined temperature level or a plurality of predetermined temperature levels. In the illustrative embodiment shown, T1 is selected to be 60° C., T2 is selected to be 70° C., and T3 is selected to be 80° C. In operation, comparator 111 will generate an output C1 if the temperature sensor temperature signal at the input to the comparator indicates that the corresponding temperature sensor is at a temperature that is greater than T1. Similarly, comparator 111 will generate an output C2 if the temperature sensor is at a temperature greater than T2, and will generate an output C3 if the temperature sensor is at a temperature greater than T3. If a fault condition is detected for a sensor, an output C4 is generated. From the foregoing, it will be apparent that if a temperature sensor temperature signal is indicative of a temperature that is greater than T2, both C1 and C2 outputs will be provided and if the temperature signal is greater than T3, all of C1, C2, and C3 outputs will be provided.

Each of the predetermined temperature levels corresponding to T1, T2, T3 is provided by a bandgap and reference level circuit 113. In the circuit shown, the temperature sensors s1-s8 operate so as to provide output voltage levels such that for temperatures T1 selected to be 60° C., T2 selected to be 70° C., and T3 selected to be 80° C. the corresponding voltages are 2.6, 2.7, and 2.8 Volts.

The outputs of comparator 111 are coupled to a single line interface circuit 115. Interface circuit 115 interfaces the comparator to a single signal line by converting the output indications C1, C2, C3, C4 of comparator 113 into a pulse width modulated signal PWM. In doing the conversion, interface 115 may be operated such that if any one of the sensors s1-s8 is above T1, a combined output indication is provided indicating that at least one thermal zone is above temperature T1. Similarly if at least one temperature sensor s1-s8 is above temperature level T2, a combined indication is provided with outputs C1 and C2. Yet further if at least one temperature sensor s1-s8 is above temperature level T3, a combined indication is provided with outputs C1, C2, and C3.

One particularly advantageous aspect of the present invention is that by providing a single line output PWM, temperature manager 110, provides an output that provides an output indication that at least one thermal zone, or in this embodiment one battery cell b1-b8 is at a predetermined temperature that exceeds one or more of a plurality of predetermined temperature limits.

The output PWM of temperature manager 110 is coupled to a utilization circuit which in the illustrative embodiment of FIG. 2 is a processor 150. Processor 150 is responsive to output PWM to initiate a predetermined action. Bt way of example, processor 150 may cause apparatus that is powered by battery pack 101 to initiate certain actions based upon the temperature of the battery cells b1-b8. For example, should temperature level T3 be exceeded, a potentially harmful condition may be at hand and processor 150 may immediately disconnect battery pack 101 from its load.

An additional advantageous aspect of the invention is that a timer and wake up circuit 117 is provided that operates such that the temperature sensors s1-s8 and temperature manager 110 are powered down except for periodically occurring intervals during which each of the temperature sensors s1-s8 is energized one at a time and the temperature manager 110 is operated to determine whether the temperature of each temperature sensor s1-s8 exceeds one or more of the predetermined temperature levels. After each periodic interval in which temperatures are sampled and compared to predetermined temperatures, the sensors s1-s8 and temperature manager 110 are powered down until the next periodic interval.

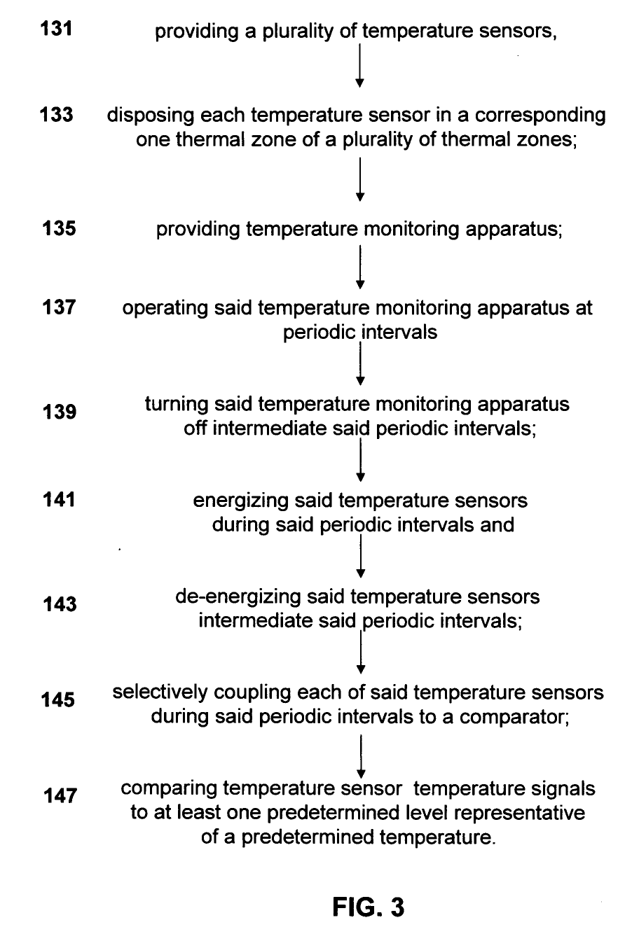

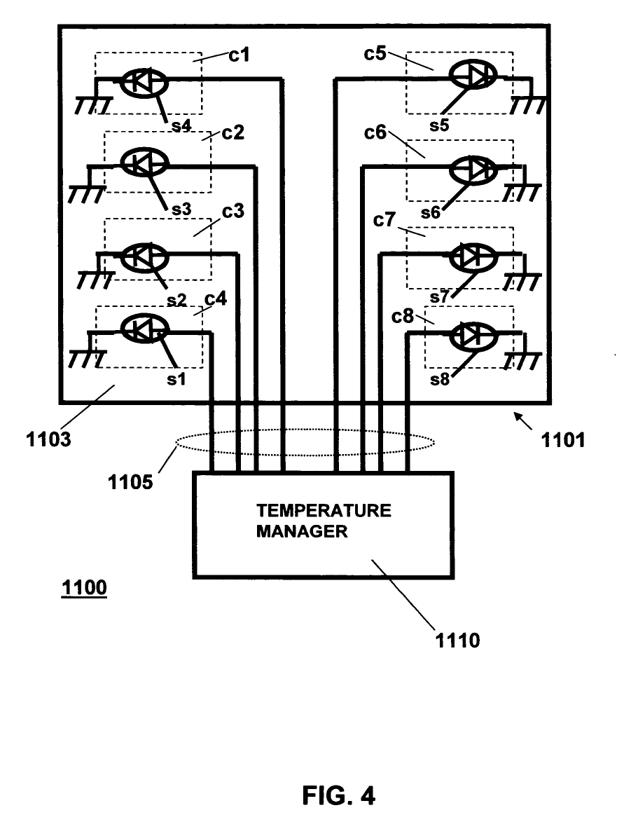

Turning now to FIG. 3, the method of the invention is shown in flow diagram form. As indicated at step 131, the method of the illustrative embodiment includes providing a plurality of temperature sensors. A step of disposing each temperature sensor in a corresponding one thermal zone of a plurality of thermal zones is provided at step 133. The thermal zones may be thermal zones of defined by battery cells of a battery pack as shown in FIG. 1, or zones of a circuit board as shown in FIG. 4, described below, or thermal zones of other apparatus. Step 135 is a step of providing temperature monitoring apparatus and step 137 is operating the temperature monitoring apparatus at periodic intervals. The temperature monitoring apparatus is turned off intermediate the periodic intervals at step 139. At step 141, the temperature sensors are energized during the periodic intervals and are de-energized intermediate the periodic intervals at step 143. During the periodic intervals, the each temperature sensor is coupled to a comparator as indicated at step 145. The temperature sensor temperature signals are compared to at least one predetermined level representative of a predetermined temperature at step 147.

In the illustrative embodiment shown in FIGS. 1 and 2, the temperature sensor signals are compared with a plurality of levels representative of a plurality of predetermined temperature steps. In addition, the temperature sensor temperature signals are compared to a predetermined reference to detect whether there has been a temperature sensor failure.

Although not shown in FIG. 3, as described in conjunction with the temperature manager of FIG. 2, the method of the invention also includes providing an output indicative of the temperatures of said temperature sensors relative to the corresponding plurality of temperatures. The method further includes providing the output via a single output line and providing the output as a pulse width modulated signal.

Turning now to FIG. 4, other apparatus 1101 to which the principles of the invention may be applied is shown. Apparatus 1101 includes a circuit board 1103 which includes a plurality of heat generating components or elements c1-c8 that define thermal zones. A corresponding plurality of temperature sensors s1-s8 is provided. Each temperature sensor is disposed proximate a thermal zone to monitor the temperature at the thermal zone. Circuit board 1103 may, for example, be a motherboard having a microprocessor chip disposed thereon along with other heat generating components. Although eight sensors and eight thermal zones are shown, those skilled in the art will appreciate that fewer or more thermal zones may be monitored.

The outputs from each of the sensors s1-s8 are coupled to a temperature manager 1110. Operation of temperature manager 1110 is the same as described above with respect to temperature manager 110.

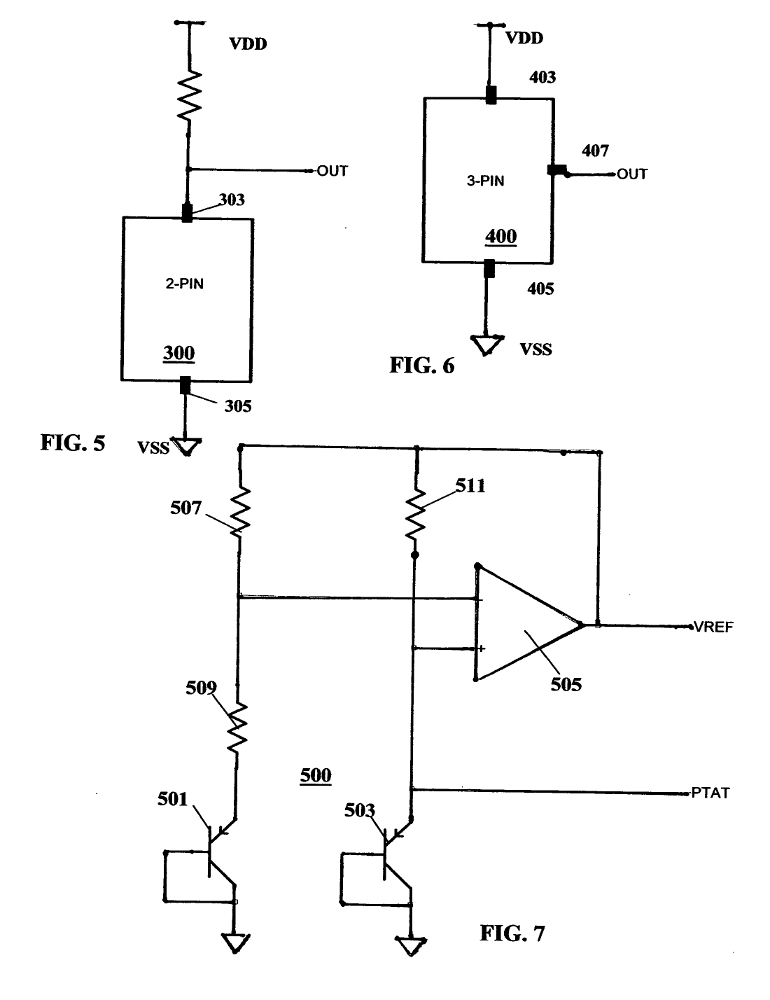

The temperature sensors s1-s8 may be configured as either a two terminal device 300 as represented in FIG. 5 or as a three terminal device 400 as represented in FIG. 6. Temperature sensors 300, 400 shown in FIGS. 5 and 6 have the distinct advantage over thermistor sensors in that the characteristic curve of the temperature sensor of the invention is highly linear and highly accurate. In addition, temperature sensors 300, 400 of the present invention are significantly smaller than thermistors and additionally require very low operating current.

Each of the temperature sensors 300, 400 utilize a bandgap circuit 500. A bandgap circuit of a type that is advantageously utilized in sensors 300, 400 is shown in FIG. 7. Bandgap circuit 500 includes transistors 501, 503. Transistors 501, 503 are connected in a diode configuration wherein the base of each transistor is connected to its collector, thereby forming PN junctions that are used for measuring temperature. The junctions can have equal areas or have unequal areas.

Amplifier 505 provides a reference voltage Vref that is coupled to diode connected transistor 501 through serially resistors 507, 509. Vref is also coupled to diode transistor 503 through resistor 511. Resistors 507 and 511 can be matched or have different values. Resistor 509 provides an offset between the voltages applied to the inputs of amplifier 501 and this offset remains relatively constant. The emitter of either transistor 501 or 503 can be used as the output terminal for the circuit. In bandgap circuit 500, output PTAT is coupled to the emitter of transistor 503. Changes in temperature of the PN junctions of transistors 501, 503 produce changes in the in the voltage drops across transistors 501, 503.

Bandgap circuit 500 generates two voltages Vref and PTAT. These voltages are linear to within 10 mvolts over a 150° C. temperature range in the illustrative embodiments of the invention. PTAT is a reference that is inversely proportional to temperature.

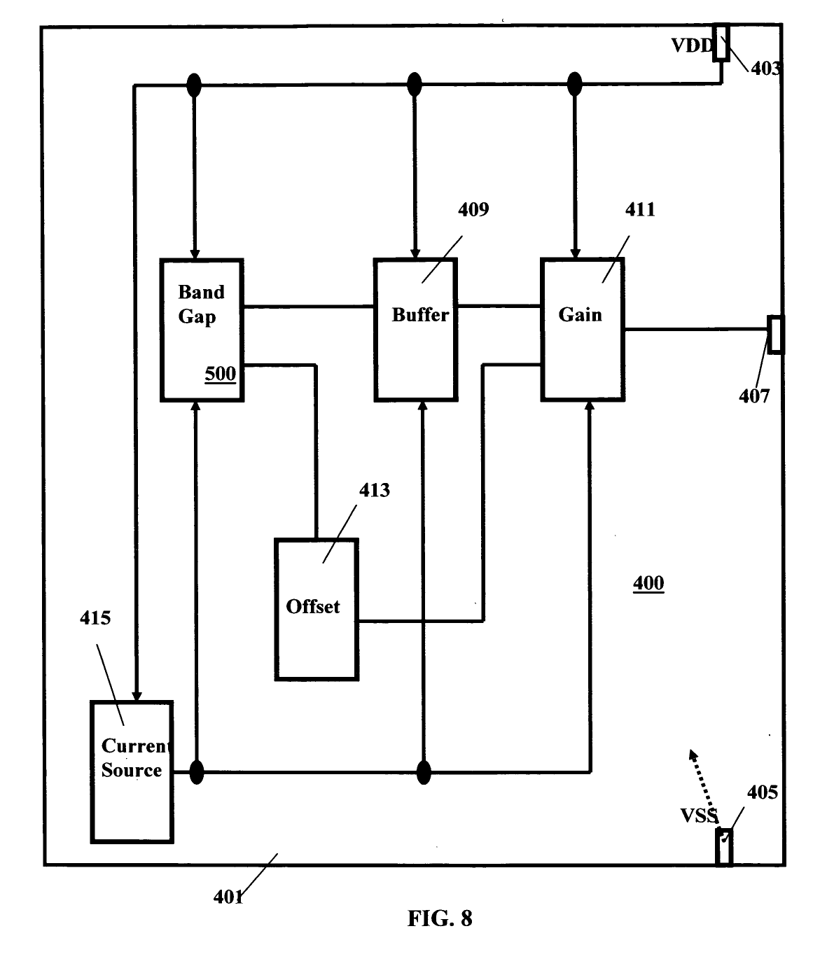

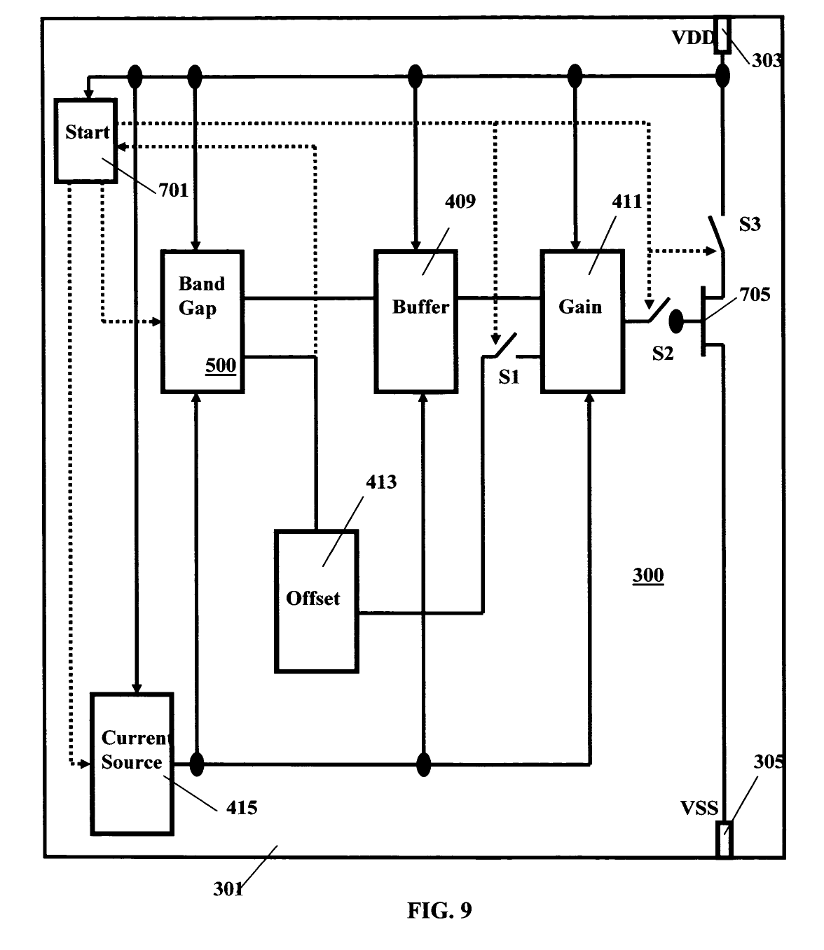

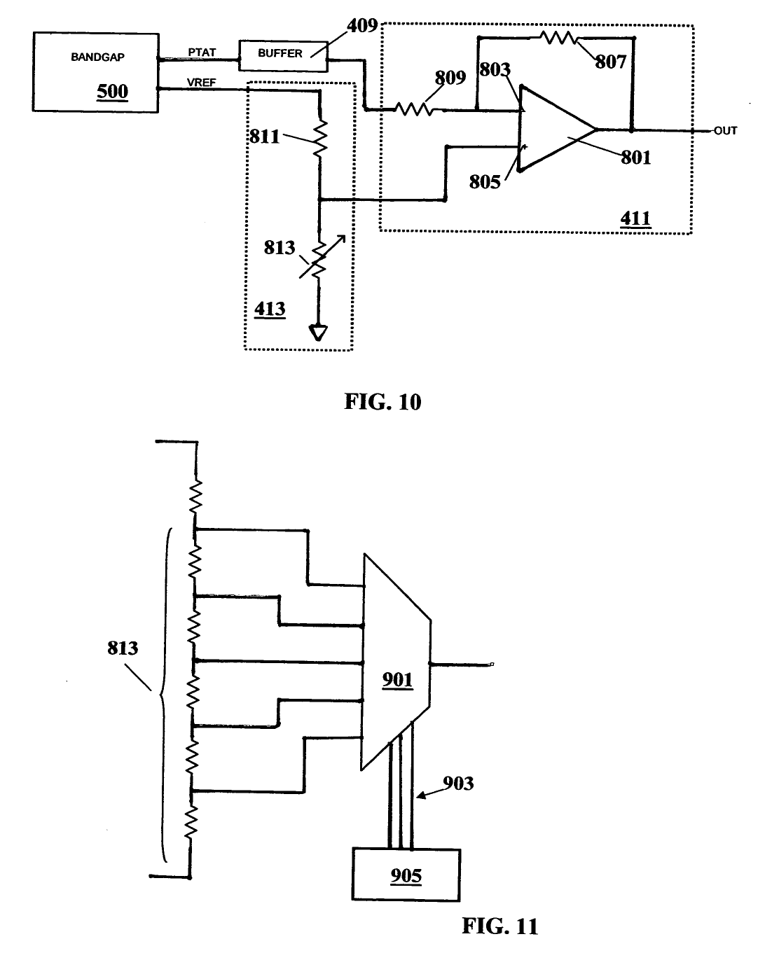

FIGS. 8 and 9 illustrate the temperature sensors 400, 300, respectively in block diagram form. Each temperature sensor 400, 300 of the present invention is fabricated as a single silicon die 401, 301, respectively. Each temperature sensor 400, 300 comprises a bandgap circuit 500, an offset block 413, a buffer circuit 409 and a gain block 411. In addition, each that has four major functional blocks integrated into the die 101. The four major functional blocks are a bandgap reference 103, an offset block 105, a gain block 107 and an amplification block 109. Still further, each temperature sensor 400, 300 includes a current source 415.

The three terminal sensor circuit of FIG. 8 has one terminal, terminal 403, coupleable to one voltage polarity, a second terminal, terminal 405 coupleable to a second voltage polarity and a third terminal, terminal 407 that provides the temperature determined output signal to a utilization circuit which is not shown in the drawing figures. As the temperature of substrate 401 changes, the output signal at terminal 407 varies.

Turning now to FIG. 9, temperature sensor 300 further includes a start up circuit 701 and controlled switches S1, S2, S3. Start up circuit 701 determines when the supply voltage supplied to sensor 300 has reached a predetermined potential and that the current source 415 and bandgap 500 are also in an operational state. Start up circuit 701 assures that at power on or subsequent to a power interruption or disruption that sensor 300 operates appropriately. FET 705 is coupled to the output of gain block 411 and between terminals 303, 305.

The PTAT output of bandgap 500 is coupled to buffer 409. Buffer 409 provides a high impedance load for bandgap circuit 500. The output of buffer 409 is proportional to, and preferably equal to, the PTAT output signal from bandgap

The gain block 411 has one input coupled to the output of buffer 409 and a second input coupled to the offset circuit 413.

FIG. 10 illustrates details of gain block 411 and offset circuit 413 in greater detail. Gain block 411 comprises an operational amplifier 801 having differential inputs 803, 805. Operational amplifier 801 has one input coupled through resistor 809 to the output of voltage buffer 409 and a second input 805 coupled to offset circuit 413. A resistor 807 is connected in a feedback arrangement with amplifier 801. Resistor 801 is selected to determine the gain of gain block 411.

Offset circuit 413 is the functional equivalent of two series connected resistors 811, 813. Resistors 811, 813 are serially coupled to the Vref output. Although resistor 813 is shown schematically as a variable resistor, the resistance value of resistor 813 is, in the illustrative embodiment, selectable during manufacture of the temperature sensor 300, 400. The value of resistor 813 is selected during calibration of the temperature sensor. The value of resistor 813 determines the offset voltage to amplifier 801 of gain block 411.

The offset resistance value varies from part to part due to wafer processing. In accordance with one aspect of the present invention, wafer level calibration is performed on temperature sensors 300, 400. Resistor structure 813 is shown in detail in FIG. 11. Resistor 813 comprises a plurality of resistances coupled to a multiplexer 901. Multiplexer 901 have selection inputs 903 that are coupled to fusible links 905. Fusible links 905 are selectively “blown” to set the value of resistor 813.

The invention has been described in terms of various embodiments. It is not intended that the invention be limited to the illustrative embodiments. It will be apparent to those skilled in the art that various modifications and changes may be made to the embodiments without departing from the spirit or scope of the invention. Accordingly, it is intended that the invention be limited only by the claims appended hereto.

1. Apparatus, comprising:
a plurality of temperature sensors each temperature sensor being operable to generate a signal representative of the temperature of said temperature sensor;
a comparator circuit, said comparator circuit being operable to compare a temperature sensor temperature signal to at least one predetermined level representative of a predetermined temperature;
a selector circuit coupled to each of said plurality of temperature sensors and to said comparator circuit, said selector circuit adapted to selectively activate said temperature sensors, said circuit further adapted to couple outputs from each said selectively activated temperature sensor to said comparator circuit;
a control circuit coupled to said selector circuit, said control circuit adapted to energize said selector circuit at predetermined intervals, and said control circuit adapted to cause said selector to selectively activate each of said temperature sensors one at a time during said predetermined intervals and to cause said selector to couple each selected temperature sensor to said comparator circuit.

2. Apparatus in accordance with claim 1, comprising:
a silicon substrate having said comparator circuit, said selector circuit and said control circuit formed therein.

3. Apparatus in accordance with claim 1, comprising:
a current source coupled to said selector circuit and adapted to energize a temperature sensor selected by said selector circuit.

4. Apparatus in accordance with claim 3, comprising: a silicon substrate having said comparator circuit, said selector circuit, said control circuit, and said current source formed therein.

5. Apparatus in accordance with claim 1, wherein:
said comparator circuit is operable to compare a temperature sensor temperature signal to a plurality of predetermined levels each representative of a corresponding one of a plurality of predetermined temperatures.

6. Apparatus in accordance with claim 5, comprising:
an interface circuit coupled to said comparator to interface said comparator circuit to a single wire output.

7. Apparatus in accordance with claim 6, wherein:
said interface circuit generates pulse width modulated signals.

8. Apparatus in accordance with claim 1, wherein:
said comparator circuit is operable to determine if a temperature sensor is inoperable.

9. Apparatus in accordance with claim 1, wherein:
said comparator circuit is operable to compare said temperature signal to said at least one predetermined level representative of a predetermined temperature and to a second predetermined level representative of a second predetermined temperature.

10. Apparatus in accordance with claim 9, wherein:
said comparator circuit is operable to compare said temperature signal to a third predetermined level representative of a third predetermined temperature.

11. Apparatus in accordance with claim 1, wherein
each of said temperature sensors is disposed in a different thermal zone.

12. Apparatus in accordance with claim 11, comprising:
a substrate, each of said temperature sensors being disposed on said substrate.

13. Apparatus in accordance with claim 11, wherein:
said substrate is a flexible substrate.

14. Apparatus in accordance with claim 14, wherein;
said substrate is disposed in proximity to a plurality of batteries.

15. Apparatus in accordance with claim 14, wherein:
each battery of said plurality of batteries comprises a lithium ion type battery.

16. Apparatus in accordance with claim 12, wherein:
said substrate comprises a circuit board.

17. Apparatus in accordance with claim 16, wherein:
said circuit board comprises a mother board.

18. Apparatus in accordance with claim 17, wherein:
said mother board comprises a microprocessor.

19. Apparatus in accordance with claim 1, wherein:
each temperature sensor of said plurality of sensors comprises a silicon substrate, said silicon substrate having formed thereon a bandgap, an offset circuit for providing calibration offsets; and a gain block.

20. Apparatus in accordance with claim 19, wherein:
said offset block comprises a plurality of resistors formed in said silicon substrate, and a programmable link structure configurable to provide a predetermined offset such that said temperature sensor is permanently calibrated.

21. A method for monitoring temperature for apparatus having a plurality of thermal zones, said method comprising:
providing a plurality of temperature sensors, each temperature sensor being operable to generate a signal representative of the temperature of said temperature sensor;
disposing each temperature sensor in a corresponding one thermal zone of a plurality of thermal zones;
providing temperature monitoring apparatus;
operating said temperature monitoring apparatus at periodic intervals and turning said temperature monitoring apparatus off intermediate said periodic intervals;
energizing said temperature sensors during said periodic intervals and de-energizing said temperature sensors intermediate said periodic intervals;
selectively coupling each of said temperature sensors during said periodic intervals to a comparator;
comparing temperature sensor temperature signals to at least one predetermined level representative of a predetermined temperature.

22. A method in accordance with claim 21, comprising:
selectively activating each said temperature sensor of said plurality of temperature sensors one at a time during said predetermined intervals; and
coupling each activated temperature sensor to said comparator during each of said predetermined intervals.

23. A method in accordance with claim 22, comprising:
providing a single current source for energizing each of said temperature sensors; and
coupling said single current source to each of said temperature sensors one at a time during said periodic intervals.

24. A method in accordance with claim 23, comprising:
comparing said temperature sensor temperature signals to a plurality of predetermined levels each representative of a corresponding predetermined temperature of a plurality of temperatures.

25. A method in accordance with claim 24, comprising:
providing an output indicative of the temperatures of said temperature sensors relative to said corresponding plurality of temperatures.

26. A method in accordance with claim 25, comprising:
providing said output via a single output line.

27. A method in accordance with claim 26, comprising:
providing said output as a pulse width modulated signal

28. A method in accordance with claim 21, comprising:
comparing said temperature sensor temperature signals to said at least one predetermined level representative of a predetermined temperature.

29. A method in accordance with claim 28, comprising:
providing an output as a result of said comparison step; and
coupling said output to a single output line.

30. A method in accordance with claim 29, comprising:
providing said output as a pulse width modulated signal.

31. A method in accordance with claim 21, comprising:
providing an output indicative of the temperatures of said temperature sensors relative to said at least one predetermined level representative of a predetermined temperature.

32. A method in accordance with claim 31, comprising:
providing said output via a single output line.

33. A method in accordance with claim 32, comprising:
providing said output as a pulse width modulated signal

33. A method in accordance with claim 21, comprising:
disposing each of said temperature sensors proximate a battery cell of a battery pack.

34. A method in accordance with claim 21, comprising:
disposing each of said temperature sensors on a circuit substrate.

35. A method in accordance with claim 34, comprising:
disposing said substrate proximate a battery pack such that each said temperature sensor is proximate one battery cell of said battery pack.

36. A method in accordance with claim 21, comprising:
disposing each of said temperature sensors on a circuit board.

37. A method in accordance with claim 21, comprising:
disposing each of said temperature sensors on a mother board having a microprocessor disposed thereon.

38. A method in accordance with claim 21, comprising:
disposing each of said temperature sensors proximate a corresponding battery cell of a lithium ion battery pack.

39. A lithium ion battery pack with thermal protection, comprising:
a plurality of battery cells;
a plurality of temperature sensors each temperature sensor being operable to generate a signal representative of the temperature of said temperature sensor, each said temperature sensor being disposed proximate a corresponding one of said battery cells;
a comparator circuit, said comparator circuit being operable to compare a temperature sensor temperature signal to at least one predetermined level representative of a predetermined temperature;
a selector circuit coupled to each of said plurality of temperature sensors and to said comparator circuit, said selector circuit adapted to selectively activate said temperature sensors, said circuit further adapted to couple outputs from each said selectively activated temperature sensor to said comparator circuit;
a control circuit coupled to said selector circuit, said control circuit adapted to energize said selector circuit at predetermined intervals, and said control circuit adapted to cause said selector to selectively activate each of said temperature sensors one at a time during said predetermined intervals and to cause said selector to couple each selected temperature sensor to said comparator circuit;
an interface circuit coupled to said control circuit for generating output signals representative of the thermal condition of said battery pack and
a battery circuit, said battery circuit coupled to said interface circuit for controlling operation of said battery pack.

40. A lithium ion battery pack in accordance with claim 39, comprising:
a silicon substrate having said comparator circuit, said selector circuit and said control circuit formed therein.

41. A lithium ion battery pack in accordance with claim 39, comprising:
a current source coupled to said selector circuit and adapted to energize a temperature sensor selected by said selector circuit.

42. A lithium ion battery pack in accordance with claim 41, comprising:
a silicon substrate having said comparator circuit, said selector circuit, said control circuit, and said current source formed therein.

43. A lithium ion battery pack in accordance with claim 39, wherein:
said comparator circuit is operable to compare a temperature sensor temperature signal to a plurality of predetermined levels each representative of a corresponding one of a plurality of predetermined temperatures.

44. A lithium ion battery pack in accordance with claim 43, comprising:
an interface circuit coupled to said comparator to interface said comparator circuit to a single wire output.

45. A lithium ion battery pack in accordance with claim 44, wherein:
said interface circuit generates pulse width modulated signals.

46. A lithium ion battery pack in accordance with claim 39, wherein:
said comparator circuit is operable to determine if a temperature sensor is inoperable.

47. A lithium ion battery pack in accordance with claim 39, wherein:
said comparator circuit is operable to compare said temperature signal to said at least one predetermined level representative of a predetermined temperature and to a second predetermined level representative of a second predetermined temperature.

48. A lithium ion battery pack in accordance with claim 47, wherein:
said comparator circuit is operable to compare said temperature signal to a third predetermined level representative of a third predetermined temperature.

49. A lithium ion battery pack in accordance with claim 48, comprising:
a substrate, each of said temperature sensors being disposed on said substrate.

50. A lithium ion battery pack in accordance with claim 49, wherein:
said substrate is a flexible substrate.

51. Apparatus, comprising:
a circuit board carrying a plurality of components and having a plurality of thermal zones;
a plurality of temperature sensors each temperature sensor being operable to generate a signal representative of the temperature of said temperature sensor, each said temperature sensor being disposed proximate a corresponding one of said thermal zones;
a comparator circuit, said comparator circuit being operable to compare a temperature sensor temperature signal to at least one predetermined level representative of a predetermined temperature;
a selector circuit coupled to each of said plurality of temperature sensors and to said comparator circuit, said selector circuit adapted to selectively activate said temperature sensors, said circuit further adapted to couple outputs from each said selectively activated temperature sensor to said comparator circuit;
a control circuit coupled to said selector circuit, said control circuit adapted to energize said selector circuit at predetermined intervals, and said control circuit adapted to cause said selector to selectively activate each of said temperature sensors one at a time during said predetermined intervals and to cause said selector to couple each selected temperature sensor to said comparator circuit; and
a circuit coupled to said comparator circuit for controlling operation of one or more of said components.

52. Apparatus in accordance with claim 51, comprising:
a silicon substrate having said comparator circuit, said selector circuit, and said control circuit formed therein.

53. Apparatus in accordance with claim 51, comprising:
a current source coupled to said selector circuit and adapted to energize a temperature sensor selected by said selector circuit.

54. Apparatus in accordance with claim 53, comprising:
a silicon substrate having said comparator circuit, said selector circuit, said control circuit, and said current source formed therein.

55. Apparatus in accordance with claim 51, wherein:
said comparator circuit is operable to compare a temperature sensor temperature signal to a plurality of predetermined levels each representative of a corresponding one of a plurality of predetermined temperatures.

56. Apparatus in accordance with claim 55, comprising:
an interface circuit coupled to said comparator to interface said comparator circuit to a single wire output.

57. Apparatus in accordance with claim 56, wherein:
said interface circuit generates pulse width modulated signals.

58. Apparatus in accordance with claim 51, wherein:
said comparator circuit is operable to determine if a temperature sensor is inoperable.

59. Apparatus in accordance with claim 51, wherein:
said comparator circuit is operable to compare said temperature signal to said at least one predetermined level representative of a predetermined temperature and to a second predetermined level representative of a second predetermined temperature.

60. Apparatus in accordance with claim 59, wherein:
said comparator circuit is operable to compare said temperature signal to a third predetermined level representative of a third predetermined temperature.

61. Apparatus in accordance with claim 51, wherein:
one of said components comprises a microprocessor.

62. Apparatus in accordance with claim 51, wherein:
each temperature sensor of said plurality of sensors comprises a silicon substrate, said silicon substrate having formed thereon a bandgap, an offset circuit for providing calibration offsets; and a gain block.

63. Apparatus in accordance with claim 62, wherein:
said offset block comprises a plurality of resistors formed in said silicon substrate, and a programmable link structure configurable to provide a predetermined offset such that said temperature sensor is permanently calibrated.
